(19) United States
(12) Patent Application Publication
(10) Pub. No.: US 2019/0358791 A1
(43) Pub. Date: Nov. 28, 2019

(54) Carry Tool with Dynamic Ratchet Feature

(71) Applicant: Brian Joseph Filko, Doylestown, PA (US)

(72) Inventor: Brian Joseph Filko, Doylestown, PA (US)

(73) Assignee: Brian Joseph Filko, Doylestown, PA (US)

(21) Appl. No.: 16/415,242

(22) Filed: May 17, 2019

Related U.S. Application Data
(60) Provisional application No. 62/675,834, filed on May 24, 2018.

(51) Int. Cl. B25B 23/00; B25G 1/08; B25B 15/04

(52) U.S. Cl. CPC B25B 23/0035; B25F 1/00; B25B 15/04; B25G 1/085

(57) ABSTRACT

An improved multitool features a wrench with a dynamic ratchet feature that contacts an inserted tool bit at two flat surfaces, allowing the tool to rotate the inserted tool bit. The ratchet feature ideally is provided by a cantilever beam which bends when rotated opposite the driving direction so that the inserted tool bit remains stationary while the tool is reset to its original position. A preferred embodiment features a cavity in which a tool bit is stored for convenience to the user.

### PRIORITY CLAIM

This application claims priority from U.S. provisional application 62/675,834, filed May 24, 2018 which is incorporated by this reference as if set forth in full.

### BACKGROUND

The disclosed subject matter relates to the field of hand tools.

In recent years, there has been a demand for innovative and functional hand tools which you can easily carry with you. Individuals are always looking for a tool which has many features to fix or assemble items while on the go. The functionality of typical tools that you can carry on your keys or carry with you is limited as they can only be used for smaller fixes due to the simplistic nature of the included features. Tools in this space which are designed to carry on your keys or easily in your pocket are typically no longer than 5 inches in length, 1 inch wide, and 0.5 inches thick. They normally feature a set of wrenches which can be considered static, as in they do not dynamically change to assist the individual to fix or assemble items.

This product provides static tools but also features a dynamic ratchet feature which has never been included in a tool of this form before. The mechanism itself consists of an opening and a cantilever beam which remains rigid when driving the tool bit but easily flexes away from the opening when the tool is being rotated opposite the driving direction. The flex of the cantilever beam away from the opening allows the bit to freely rotate in the opening. This allows the individual to ratchet a tool bit without ever needing to lift the tool from the tool bit to reposition it. This feature can be proven extremely useful in tight spaces where lifting the tool off the tool bit to reposition it can be difficult or in situations where the item being ratcheted is not visible to the user.

There is a need for an improved carry tool as summarized, discussed in detail, and claimed in the following text and accompanying illustrations.

### SUMMARY

In embodiments of the described and illustrated process/device/system, the EverRatchet product is described. The main body may consist of an alloy with many static tools. These static tools may consist of pry bars, wrenches, files, measuring devices, wire strippers, screw drivers, box openers, bottle openers and various other tools. The feature being discussed in detail is the dynamic ratchet feature. They dynamic ratchet feature may contact the inserted tool bit at two points, one at the body of the tool and one on the cantilever beam itself. The contact points may contact the inserted tool bit at two flat surfaces which allow the tool to rotate the inserted tool bit when a force is applied to the tool. The cantilever beam may flex when rotated opposite the driving direction which may allow the inserted tool bit to remain stationary while the tool is reset to its original position. The tool may be able to rotate the inserted tool bit clockwise and counter-clockwise based on the orientation of the tool relative to the tool bits axis.

This product may be produced at a smaller size and still operate as intended although it may become less practical to handle and operate. On the opposing end, it may be made larger and still operate as intended. The product size may have been selected to be optimal for both function and portability. This product may be made from various alternative materials and could still able to function as expected. The applied force required to reset the contact point on the cantilever beam may be obtained alternatively by using a compressive component such as a spring, magnet or rubber band and the device could still operate as intended. The opening shape of the ratchet area, cantilever beam, and contact points may be modified and the product could still function as expected. The ratchet feature may be produced at a different size or thickness to accept a different tool bit, size shaft or a different shape shaft. The ratchet feature is intended to be used with the included tool bit but may be used with other tool bits or shafts that fit into the opening. The tool bit may have a different number of flat surfaces and still operate as intended.

The following detailed description includes references to the accompanying illustrations which form a part of this detailed description. Example embodiments are described in enough detail to enable those skilled in the art to practice the present subject matter. However, it will be apparent to one of ordinary skill in the art that the present invention may be practiced without some of these specific details. In other instances, well-known methods, procedures and components have not been described in detail so as not to unnecessarily obscure aspects of the embodiments. The embodiments can be combined, other embodiments can be utilized, or structural and method of use changes can be made without departing from the scope of what is defined and claimed. The following detailed description is, therefore, not to be taken as a limiting sense, and the scope is defined by the appended claims and their equivalents which are to be understood in their broadest possible sense.

In this document, the terms “a” or “an” are used, as is common in patent documents, to include one or more than one. Furthermore, the term “or” is used to refer to a nonexclusive “or,” such that “A or B” includes “A but not B,” “B but not A,” and “A and B,” unless otherwise indicated.

### BRIEF DESCRIPTION OF THE DRAWINGS

Embodiments of the described apparatus are illustrated by way of example in the figures of the accompanying drawing sheets, in which like references indicate similar elements.

FIG. 1 is a top isometric view of the device with the tool bit stored according to some embodiments;

FIG. 2 is a top isometric view of the device with a tool bit in the ratchet position according to some embodiments;

FIG. 3 is a top plan view of the device with the tool bit stored according to some embodiments;

FIG. 4 is a top plan view of the device with the tool bit in the ratchet position according to some embodiments;

FIG. 5A-F is a top plan view of the device showing a counter-clockwise motion of the bit with a clockwise reset of the tool with the bit remaining in the same position according to some embodiments;

FIG. 6A is a top plan view of the device and an applied force to rotate the bit counter-clockwise and FIG. 6B is a top plan view of the device and an applied force to rotate the bit clockwise according to some embodiments;

FIG. 7 is a top isometric view of the device with the tool bit stored according to some embodiments;

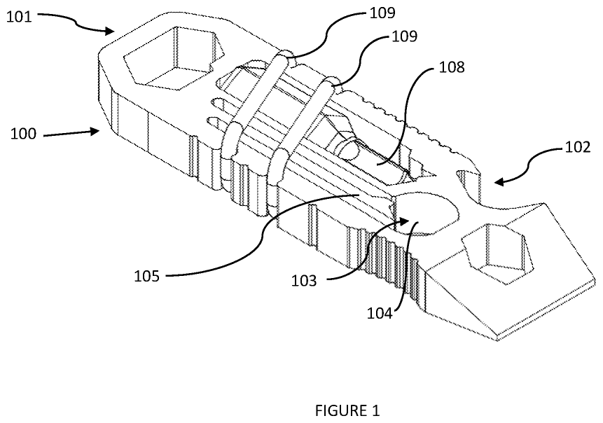

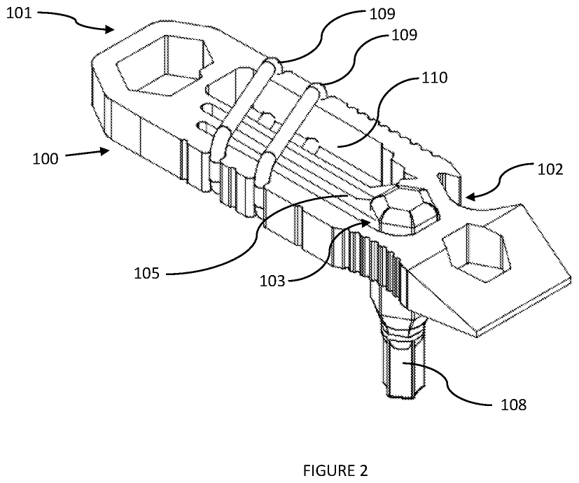

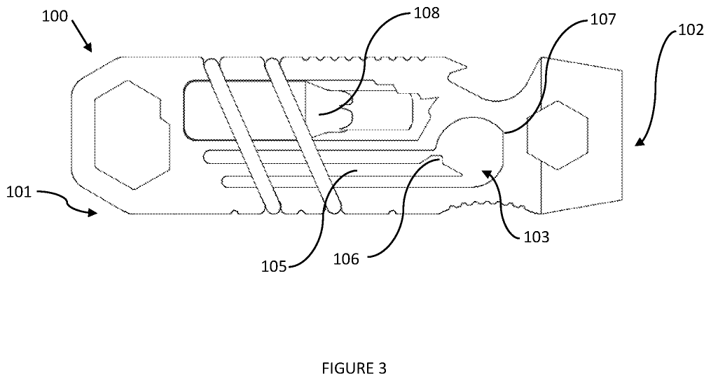

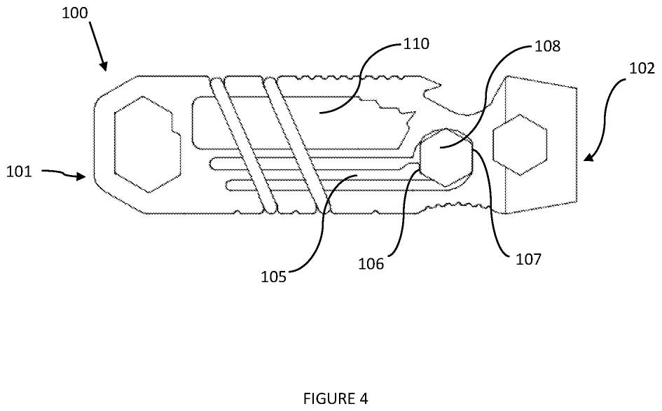

### DETAILED DESCRIPTION

This disclosure relates to an improved carry tool with dynamic ratchet feature.

This product may consist of a first body 100 which may be made of an alloy material. The first body 100 may consist of a grip end 101 and a tool end 102. The first body 100 may consist of static tools but also a dynamic ratchet feature 103 on the tool end 102. The tool end 102 may consist of a dynamic ratchet feature 103. The dynamic ratchet feature 103 may consist of a ratchet opening 104 and a ratchet cantilever beam 105. The first body 100 and its features may be made of another material, multiple components or a different shape and may still be able to function as expected. The first body 100 may carry a tool bit 108 which is held in place by two tool bit bands 109 when not in use. The tool bit 108 may be replaced with other standard tool bits or with another object which can fit in the storage cavity 110 in the first body 100.

The tool bit bands 109 may be made from an alternative material or a varying quantity and may still be able to function as expected. The position of the tool bit bands 109 and angular position relative to the storage cavity 110 may be altered and may still be able to function as expected. The tool bit bands 109 may be spaced in a manor to hold the tool bit 108 if rotated perpendicular to the main face of the first body 100 and inserted between the two tool bit bands 109 through the storage cavity 110 area.

An alternative method of storing the tool bit 108 in the storage cavity 110 may be by using a friction fit between the storage cavity 110 and tool bit 108 or by using a magnet. An alternative method of storing the tool bit 108 in the storage cavity 110 may be by using a cantilever beam with a feature that may capture the cross section of the tool bit 108. The storage cavity 110 may be used to store an alternative component apart from the tool bit 108.

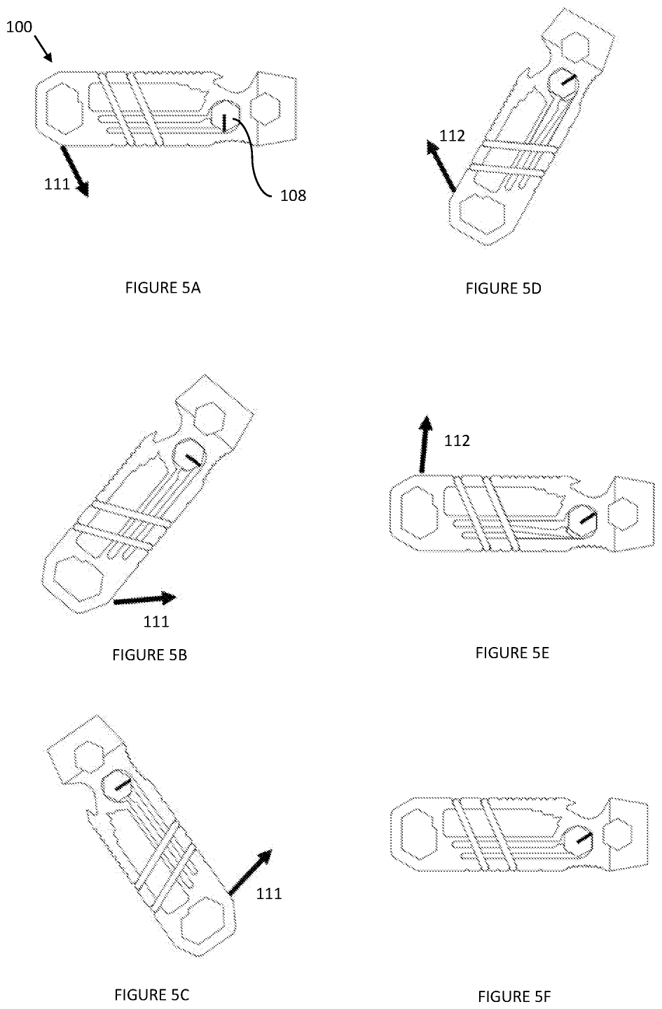

The tool bit 108 may be held in the dynamic ratchet opening 104 when using the dynamic ratcheting feature 103. The tool bit 108 may be contacted at two main points inside the dynamic ratchet opening 104; the ratchet resistant point 106 and the first body resistant point 107. These contact points may allow the dynamic ratchet feature 103 to engage and rotate the tool bit 108 counter-clockwise as shown in FIG. 5A-5C. The first body 100 may then be rotated back clockwise allowing the ratchet cantilever beam 105 to deflect away from the dynamic ratchet opening 104 making clearance for the first body 100 to freely rotate around the tool bit 108 as shown in FIG. 5D-5F. The deflection of the dynamic cantilever beam 105 may occur due to contacting the stationary tool bit 108 as the first body 100 is rotated opposite the driving direction. The dynamic ratchet feature 103 may function by moving the first body 100 counter-clockwise then clockwise repeatedly until the tool bit 108 rotates to the desired position.

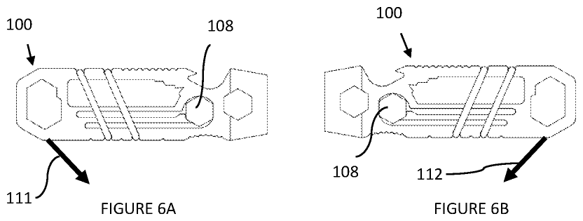

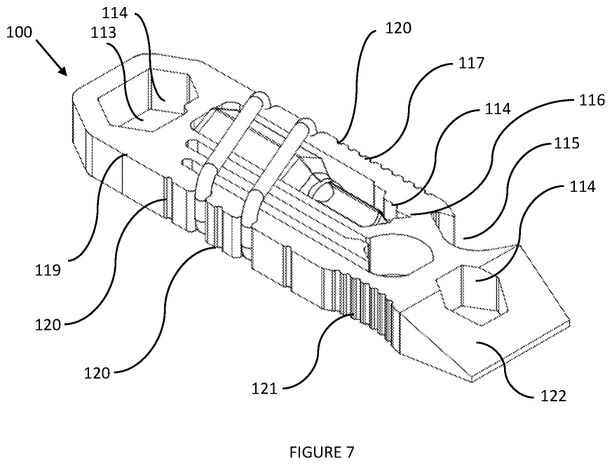

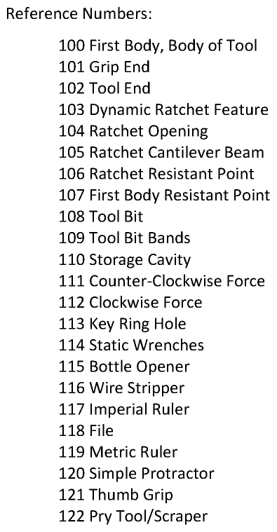

The dynamic ratchet feature 103 may be used to rotate the tool bit 108 either clockwise or counter-clockwise based on the orientation of the first body 100 to the tool bit 108. Inverting the first body 100 along the axis of the tool bit 108 may allow the dynamic ratchet feature 103 to rotate the tool bit 108 either clockwise or counter-clockwise. As seen in FIG. 6A, the first body 100 may be in an orientation to rotate the tool bit 108 counter-clockwise when a counter-clockwise force 111 is applied. In FIG. 6B, the first body 100 may be inverted to rotate the tool bit 108 clockwise when a clockwise force 112 is applied.

The ratchet opening 104 may be made be of an alternative shape which may be able to appropriately hold and ratchet the tool bit 108. A tool bit 108 is provided to the user with the product but the user may want to replace the tool bit 108 with something that they more frequently require access to. The dynamic ratchet feature 103 may be used to ratchet other items that are not tool bit 108 such as a bolt head or a shaft which fits in the ratchet opening 104.

In an alternative embodiment, a compression component could be used to apply the necessary force for the ratchet resistant point 106 to reset in operation. The placement of a compression component such as a spring, magnet or rubber behind the ratchet resistant point 106 would provide the necessary force to move it back in to position.

The first body 100 may also have other static tools and features. It may have a key ring hole 113 to which an individual can attach a lanyard, sting, key ring, or other components. It may have static wrenches 114 of assorted sizes. It may have a bottle opener 115, wire stripper 116, imperial ruler 117, file 118, metric ruler 119, simple protractor 120 or thumb grip 121. It may also feature a pry tool/scraper 122 which may be used for opening boxes, scratching flat surfaces, prying open item, use as a flat head screwdriver, scoring material or opening cans.

In the foregoing description, embodiments are described as a plurality of individual structures, and this is solely for the sake of illustration. Accordingly, it is contemplated that some additional structures may be added, some structures may be changed or omitted, and the order of the structures may be re-arranged, without leaving the sense and understanding of the device as claimed.

1. A hand tool comprising:
a. a first body having a grip end and a tool end;
b. wherein said tool end has a ratchet opening adapted to receive a tool bit wherein said ratchet opening has at least two resistant points;
c. a cantilever beam supported on said grip end having a ratchet end wherein said ratchet end has at least one said resistant point adapted to contact said tool bit when engaged; and
d. wherein said first body has at least one said resistant point on said tool end adapted to contact said tool bit when engaged.

2. The hand tool of claim 1 wherein said cantilever beam is integral to said first body.

3. The hand tool of claim 1 wherein at least one said resistant point is biased to move into said ratchet opening by a compression component.

4. The hand tool of claim 1 wherein at least one said resistant point is biased to move into said ratchet opening by a magnetic force.

5. The hand tool of claim 1 further comprising an opening in said first body adapted to store said tool bit.

6. A hand tool comprising:
a. a first body having a grip end and a tool end;
b. wherein said tool end has an opening adapted to receive a tool bit;
c. wherein said opening has at least two resistant points adapted to apply rotational force to said tool bit; and
d. wherein at least one said resistant point is adapted to move away from said opening when said tool is in use.

7. The hand tool of claim 6 wherein one at least one said resistant point is integral to said first body.

8. The hand tool of claim 6 wherein one at least one said resistant point is integral to a longitudinal beam supported on said grip end of said body.

9. The hand tool of claim 6 wherein said at least two said resistant points comprise a ratchet.

10. The hand tool of claim 6 wherein at least one said resistant point is biased to move into said opening by a compression component.

11. The hand tool of claim 6 wherein at least one said resistant point is biased to move into said opening by a magnetic force.

12. The hand tool of claim 6 further comprising an opening in said first body adapted to store said tool bit.

13. A hand tool comprising:
a. a first body having a grip end and a tool end;
b. a ratchet feature comprising a ratchet opening adapted to receive a tool bit at said tool end wherein said ratchet opening has at least one resistant point;
c. a longitudinal beam supported on said grip end of said first body which extends into said ratchet opening wherein said longitudinal beam comprises at least one resistant point at said ratchet opening; and
d. wherein a spring force is applied in a direction off plane to said longitudinal beam such that at least one said resistant point is forced into said ratchet opening.

14. The hand tool of claim 13 wherein said spring force is applied by at least one said compression component.

15. The hand tool of claim 13 wherein said spring force is applied by at least one magnetic force.

16. The hand tool of claim 13 further comprising an opening in said first body adapted to store said tool bit.
